(19) United States
(12) Patent Application Publication
(10) Pub. No.: US 2010/0203337 A1
(43) Pub. Date: Aug. 12, 2010

(54) ETHYLENE-BASED RESIN COMPOSITE PARTICLE AND ENVIRONMENTALLY FRIENDLY METHOD FOR PREPARING THE SAME

(76) Inventors: Shuichi Kimura, Susono-shi (JP); Kiyoshi Yagi, Susono-shi (JP); Makoto Egashira, Nagasaki-shi (JP)

Correspondence Address: EDWARDS ANGELL PALMER & DODGE LLP, P.O. BOX 55874, BOSTON, MA, 02205, US

(21) Appl. No.: 12/452,950

(22) PCT Filed: Jun. 20, 2008
(86) PCT No.: PCT/JP2008/061690

§ 371 Date: Apr. 22, 2010

(30) Foreign Application Priority Data
Jul. 30, 2007 (JP) 2007-197767

(51) Int. Cl. B32B 27/02; B05D 7/00

(52) U.S. Cl. 428/407; 427/213.3

(57) ABSTRACT

The objective of the present invention is to provide an ethylene-based composite resin composite particle having a small-sized, approximately spherical form, comprising functional filler homogeneously dispersed therein, and being compatible with other resin pellets or components.

To attain the above objective, the present invention provides an environmentally friendly method for producing an ethylene-based resin composite particle, comprising: (a) dissolving ethylene-based polymer in organic solvent separable from aqueous phase and dispersing hydrophobic filler in environment-friendly organic solvent to form solution of ethylene-based polymer in the organic solvent; (b) emulsifying the solution obtained in step (a) in non-ionic surfactant-containing aqueous solution; (c) heating the emulsion obtained in step (b) to remove the organic solvent; and (d) recovering a precipitate the ethylene-based resin composite particle containing the hydrophobic filler therein. The present invention also provides an ethylene-based resin composite particle produced by the afore-mentioned process.

### TECHNICAL FIELD

The present invention relates to an ethylene-based resin composite particle prepared by adding filler to polyethylene-based resin, and an environmentally friendly method for preparing the same.

### BACKGROUND ART

In a variety of applications, there has been highly required an enhanced composite material prepared by dispersing a filler in a resin matrix for its property modification. For example, halogen-free electrically-insulating material can be employed. For example, in the case of using polyolefin such as polyethylene and polypropylene as halogen-free electrically-insulating material, for the purpose of improving its poor flame retarding property, a relatively large amount of hydrophobic flame-retardant filler, mainly hydrophobic magnesium hydroxide has to be added. However, a composite material having the afore-mentioned functional filler dispersed in the polyolefin can only be formed in a limited form or pellet form. The foregoing pellet has a relatively large particle size as well as is generally amorphous. Therefore, the afore-mentioned composite material has only defined application when used in molding process. Further, to uniformly or homogeneously disperse the flame-retardant filler in the afore-mentioned composite material, a specific technology and apparatus has also been needed. In addition, this will be a time-consuming operation. Accordingly, in the related art, there has been highly needed an ethylene-based resin composite material having a small-sized, approximately spherical form, comprising a functional filler homogeneously dispersed therein, and being miscible or compatible with other resin pellets or components.

Meanwhile, in a case where a liquid drying process is used so as to prepare such a resin composite material, it, is difficult to control several factors needed in the preparation process. Further, since a solvent to be used the afore-mentioned process generally includes a halogen-containing compound, an ozone-damaging compound, or a carcinogenic compound as listed in GADSL (i.e., Global Automotive Declarable Substance List), the foregoing liquid drying process is not believed to correspond to an environmentally friendly process. See Japanese Publication of Un-examined Patent Applications No. 2005-15476 and No. 2003-171264. As previously described, up to now, none of references teaches or discloses that liquid drying process is applied to the preparation of such an ethylene-based resin composite material.

To solve the previously mentioned problems, there is provided herein a novel, environmentally friendly method for preparing an ethylene-based composite resin composite particle having a small-sized, approximately spherical form, comprising a functional filler homogeneously dispersed therein, and being miscible or compatible with other resin pellets or components.

### DISCLOSURE OF THE INVENTION

To solve the afore-mentioned problems, there is provided an environmentally friendly method for preparing an ethylene-based resin composite particle, comprising: (a) dissolving ethylene-based polymer in organic solvent separable from aqueous phase and dispersing hydrophobic filler in environment-friendly organic solvent to form solution of ethylene-based polymer in the organic solvent; (b) emulsifying the solution obtained in step (a) in non-ionic surfactant-containing aqueous solution; (c) heating the emulsion obtained in step (b) to remove the organic solvent; and (d) recovering a precipitate the ethylene-based resin composite particle containing the hydrophobic filler therein.

There is also provided an ethylene-based resin composite particle produced by a process comprising: (a) dissolving ethylene-based polymer in environment-friendly organic solvent separable from aqueous phase and dispersing hydrophobic filler in the organic solvent to form solution of ethylene-based polymer in the organic solvent; (b) emulsifying the solution obtained in step (a) in non-ionic surfactant-containing aqueous solution; (c) heating the emulsion obtained in step (b) to remove the organic solvent; and (d) recovering a precipitate the ethylene-based resin composite particle containing the hydrophobic filler therein.

### BRIEF DESCRIPTION OF THE DRAWINGS

FIG. 1 (FIGS. 1(a) through 1(e)) shows a transmission electro microscopy (TEM) of an ethylene-based resin composite particle. In greater detail, as a comparative example, FIG. 1(a) shows a transmission electron microscopy of an ethylene-based resin composite particle containing no hydrophobic magnesium hydroxide therein. As examples of the present invention, FIG. 1(b) shows a transmission electron microscopy of an ethylene-based resin composite particle in accordance with the present invention prepared by adding 10 parts by weight of hydrophobic magnesium hydroxide based on the total of 100 parts by weight of ethylene-based polymer used; FIG. 1(c) shows a transmission electron microscopy of an ethylene-based resin composite particle in accordance with the present invention prepared by adding 30 parts by weight of hydrophobic magnesium hydroxide based on the total of 100 parts by weight of ethylene-based polymer used; FIG. 1(d) shows a transmission electron microscopy of an ethylene-based resin composite particle in accordance with the present invention prepared by adding 50 parts by weight of hydrophobic magnesium hydroxide based on the total of 100 parts by weight of ethylene-based polymer used; and FIG. 1(e) shows a transmission electron microscopy of an ethylene-based resin composite particle in accordance with the present invention prepared by adding 70 parts by weight of hydrophobic magnesium hydroxide based on the total of 100 parts by weight of ethylene-based polymer used.

FIG. 2 shows the relationship between the amount of magnesium hydroxide originally added in the preparation process of the ethylene-based resin composite particle and the measured content of the magnesium hydroxide of the final product ethylene-based resin composite particle.

FIG. 3 shows a transmission electron microscopy and an energy dispersive C-ray spectrometry of respective molded articles. In further detail, FIGS. 3(a) and 3(b) respectively show a transmission electron microscopy of the broken-out section (i.e., fracture cross section) of a conventional molded article, and an energy dispersive C-ray spectrometry with respect to a magnesium atom in the associated broken-out section; and FIGS. 3(c) and 3(d) respectively show a transmission electron microscopy of the broken-out section (i.e., fracture cross section) of a molded article produced by the use of the ethylene-based resin composite particle in accordance with the present invention, and an energy dispersive C-ray spectrometry with respect to magnesium atom in the associated broken-out section.

### BEST MODE FOR CARRYING OUT THE INVENTION

One component, ethylene-based polymer suitably employed in accordance with the present invention can be defined as ethylene-containing copolymer. Exemplary ethylene-containing copolymer includes, but is not limited to, a low molecular weight polyethylene; a linear polyethylene such as high density polyethylene, a very high density polyethylene, a linear low density polyethylene (e.g. a general linear low density polyethylene in which butene-1 is added as a comonomer, a linear low density polyethylene (so called “HAO-LLDPE”) in which higher α-olefin such as hexene-1, octene-1, and 4-methylpentene-1 is added as a comonomer), a very low density polyethylene (e.g. a soft type VLDPE containing a large amount of comonomer such as hexene-1, octene-1, and 4-methylpenthene-1); branched polyethylene such as low density polyethylene and a copolymer with a polar monomer (e.g. ethylene-acetate copolymer, a copolymer with acrylate such as ethylene-methacrylate copolymer, ethylene-ethylacrylate copolymer and the like), a copolymer with a acid monomer such as ethylene-vinyl acetate copolymer, ethylene-metacrylic acid copolymer and the like, and a copolymer with metal salt of monomer such as anionomer (ethylene-vinyl acetate copolymer, ethylene-metacrylic acid copolymer and the like); an elastomer such as ethylene propylene rubber, ethylene-propylene-diene rubber and the like; and chlorinated compounds such as chlorinated polyethylene.

The organic solvent suitably employed in accordance with the present invention should be separable from aqueous phase and also dissolve the foregoing ethylene-based polymer therein. In addition, the organic solvent should be relatively environmentally friendly. In other words, any organic compound as listed in the GADSL is preferably avoided.

The foregoing organic solvent may be one or more compound(s) selected from the group consisting of a branched or unbranched saturated hydrocarbon including alkanes such as hexane, heptane, octane, nonane, decane, undecane, dodecane and the like, cycloalkane such as cyclohexane and the like, and a branched or unbranched unsaturated hydrocarbon including alkenes, cycloalkenes, alkynes, and the like. Preferably, the organic compound has a boiling point ranging from 70 to 100° C.

Among theses compounds, hexane, heptane, cyclohexane, octane, hexane-cyclohexane mixture, hexane-heptane mixture, hexane-octane mixture, cylohexane-heptane mixture, cyclohexane-octane mixture, or heptane-octane mixture, due to its excellent solubility of ethylene-based polymer therein, can be more preferably used as the organic solvent in accordance with the present invention.

If an organic solvent having a boiling point of about 80° C. is selected as a solvent in the practice of the present invention, it can be preferably used together with a distinct solvent being preferably separable from aqueous phase as well as not being listed in GSDSL so as to achieve volatile-reduced and highly stable organic solvent mixture. In this case, a mixed solvent will not adversely affect its intrinsic solubility of ethylene-based polymer and also have a boiling point range of 80° C. to 150° C. This additional organic solvent is preferably selected in the above listing.

The functional filler suitably used in accordance with the present invention may includes, but is not limited to, a flame retardant such as magnesium hydroxide, calcium hydroxide, aluminum hydroxide, hydrotalcite and the like, a bulking agent such as calcium carbonate and the like, a lubricant such as magnesium hydroxy stearate and the like, an anti-oxidant, a metal deactivator such as a copper inhibitor and the like, a plasticizer, an earthquake resistant, an anti-fungal agent, an anti-bacterial agent, a colorant, an ultraviolet absorber, a modifier, a reinforcing agent, a crystal neucleation agent, a processing aid, an antiozonant, and the like. The functional filler may comprise the other agent as needed.

In accordance with the present invention, the functional filler should be hydrophobic material. To satisfy this requirement, hydrophilic functional filler, when used, has to be treated with a hydrophobizing agent in advance.

The afore-mentioned hydrophobizing agent applied to the functional filler, in particular the hydrophilic functional filler, component includes, but is not limited to, a fatty acid or ester or salt thereof, a silane coupling agent, a titanate-containing coupling agent, an aluminum-containing coupling agent, and silicon oil, and the combination thereof.

The foregoing silane coupling agent include, but is not limited to, vinylethoxysilane, vinyl-tris(2-methoxy)silane, gamma-methacryloxypropyltrimethoxysilane, gamma-aminopropyltrimethoxysilane, beta-(3,4-epoxycyclohexypethyltrimethoxysilane, gamma-glycidoxypropyltrimethoxysilane or gamma-mercaptopropyltrimethoxysilane. Such silane coupling agent can preferably be employed in an amount of 0.1 to 5 percents by weight, more preferably, 0.3 to 1 percents by weight based on the total of 100 percents by weight of the hydrophilic functional filler.

Further, in order to impart enhanced hydrophobicity to the functional filler to be used in the preparation process, other coupling agents such as a titanate-containing coupling agent and an aluminum-containing coupling agent can be also efficiently employed in a similar manner.

To impart hydrophobicityto the functional filler, the foregoing fatty acids or salts or esters thereof can be efficiently employed. This fatty acid should have relatively low solubility in water or water-based solvent. Exemplary fatty acid to be suitably used in accordance with the present invention includes, but are not limited to, substituted or unsubstituted, or substituted or unsubstituted butyric acid, valeric acid, caproic acid, enanthic acid, caprylic acid, pelargonic acid, capric acid, lauric acid, myristic acid, pentadecylic acid, palmitic acid, hepatadecanoic acid, arachidonic acid, behenic acid, lignoceric acid, crotonic acid, myristoleic acid, palmitoleic acid, trans-9-octadecenoic acid, vaccenic acid, linolic acid, linolenic acid, eleostearic acid, stearidonic acid, gadoleic acid, eicosapentaenoic acid (EPA), cis-13-docosenoic acid, clupanodonic acid, docosahexaenoic acid (DHA), or cis-15-tetracosenoic acid. Particularly, it is desired to employ any saturated or unsaturated higher fatty acid, preferably any saturated or unsaturated higher fatty acid containing 14 to 24 carbon atoms, for example, oleic acid or stearic acid. The fatty acid can preferably be employed in an amount of 0.5 to 5.0 percents by weight, more preferably, 1 to 3 percents by weight based on the total of 100 percents by weight of the hydrophilic functional filler.

Exemplary silicon oil that may be useful in the practice of the invention includes methyl hydrogen polysiloxane.

The surface of the functional filler may be coated with the coupling agent via its reaction with the coupling agent under the condition leading to coupling reaction. In a case where the hydrophorbizing agent other than the coupling agent is employed to impart hydrophobicity to the functional filler, it is also be homogeneously applied to the surface of the functional filler under the predetermined condition with respect to a temperature, a period of time, or an agitation.

In accordance with the present invention, the diameter of the functional filler particle is not substantially limited to a specified range. Even the functional filler has a relatively small, micron-order diameter, which has been generally believed to be inhomogeneously dispersed in a resin matrix in accordance with a conventional technology relating to dispersion, it can be homogeneously and uniformly dispersed in ethylene-based resin composite particle, by means of the process as defined in the present invention.

Ethylene-based polymer and hydrophobic functional filler are added to the afore-mentioned solvent. Ethylene-based polymer is dissolved in the solvent, and the hydrophobic functional filler is dispersed in the solvent. As a first step, the ethylene-based polymer may be dissolved in the solvent, or the functional filler may be dispersed in the solvent. Alternatively, the ethylene-based polymer and the functional filler can be simultaneously added to the solvent. To dissolve a large amount of the ethylene-based polymer in the solvent, heating may be needed in this step.

When the ethylene-based polymer having a relatively small diameter (for example, diameter being identical to or less than 100,,m) is mixed with the hydrophobic functional filler, and the mixture thus obtained is dissolved in the solvent, the hydrophobic functional filler will be homogeneously dispersed in the solvent without any mechanical agitation or stirring. To the end, the resulting ethylene-based composite particle each can maintain uniform mixing ratio of the ethylene based polymer and the functional filler within its overall range.

In such a manner, the ethylene-based polymer is dissolved in the hydrophobic organic solvent having a boiling point lower than 100° C. Subsequently, the solution thus obtained having the hydrophobic functional filler dispersed therein can be dispersed in the non-ionic surfactant-containing aqueous solution resulting in an emulsion. In other words, this operation can be called “emulsification”.

The non-ionic surfactant suitably employed in the practice of the present invention includes, but is not limited to, polyoxyethylene alkyl ether, polyoxyethylene alkyl phenyl ether such as polyoxyethylene nonyl phenyl ether, polyoxyethylene polyoxypropylene ether, polyoxyethylene alkyl ether, polyoxyethylene alkyl ester, sorbitan fatty acid ester, polyoxyethylene sorbitan fatty acid ester, lignosulfonate such as calcium lignosulfonate, alkyl benzene sulfonate such as sodium alkyl benzene sulfonate, alkyl naphthalene sulfonate such as sodium alkyl naphthalene sulfonate, polyoxyethylene polyoxypropylene block polymer, higher fatty acid alkanol amide and the like. The foregoing non-ionic surfactants can be employed in a combination thereof. Preferably, polyoxyethylene octyl phenyl ether such as TritonX-100, TritonX-114 and the like can be preferably employed in the practice of the present invention. This is because polyoxyethylene octyl phenyl ether compounds have an excellent performance in stabilizing emulsion in comparison with conventional polymer stabilizer such as polyvinyl alcohol. Therefore, the product thus obtained also exerts excellent stability in its particle size distribution and its final shape.

The non-ionic surfactant-containing aqueous solution can be poured into the organic solvent in an amount of about 0.1 g to about 10 g, preferably about 0.5 g to about 4 g based on 100 ml of the organic solvent.

The resulting emulsion is heated to remove the organic solvent. As a result, a plurality of particles containing ethylene-based polymer and hydrophobic functional filler therein is formed and is then precipitated in the aqueous phase. Because the resulting ethylene-based resin composite particle has a micron-order diameter that is substantially identical to the diameter of the particle being present in the emulsion, the particle size is remarkably smaller than the size of the conventional resin pellet generally having a diameter in millimeter order.

The ethylene-based resin composite particle thus obtained is optionally washed with water or appropriate organic solvent, and subsequently is dried.

When the resulting ethylene resin-based composite particle is used in a molding process, it can be well mixed or blended with other ethylene-based polymer. This is because each ethylene resin-based composite particle has an approximately spherical, small-sized form, as well as contains the functional filler therein. Accordingly, the functional filler can be homogenously dispersed in the final product (i.e., a molded article). Further, the functional filler can exert its intrinsic effects or properties, and thus it can effectively prevent several possible problems, for example, strength degradation resulting from its inhomogeneous dispersion in the ethylene-based resin and the like.

In the process of preparing the foregoing ethylene-based resin composite particle, the functional filler such as magnesium hydroxide can be utilized. The ethylene-based resin composite particle can be injected into one or more desired site(s). If needed, the ethylene-based resin composite particle can be filled the desired site(s) by pressure applied thereto. In this case, heating is not specially needed. For the reason as set forth above, it is possible to efficiently insulate an electrical part having relatively low heat resistance which has not been generally believed to be readily insulted in the related art.

The present invention will be hereinafter illustrated in further detail with reference to several preferred examples.

### EXAMPLES

In a cylindrically shaped reactor having a diameter of 20 cm and a depth (i.e. a height) of 30 cm and being equipped with a stirrer having a propeller configuration and a length of 10 cm therein, 1 g of methyl hydrogen polysyloxane (a hydrophobizing agent) and 99 g of magenesium hydroxide (a flame-retardant filler) having a particle size of 0.8 ,,m and obtained from Arbemarle Co. under the name of “magnifin” were placed and then stirred at 1600 rpm for 30 minutes. Subsequently, the resulting mixture was heated at 150° C. for 2 hours to prepare hydrophobic magnesium hydroxide that has been treated with the hydrophobizing agent.

As organic solvent, cyclohexane-heptane mixture (1:1 of mixing ratio in volume) was used that is hydrophobic and has a boiling point lower than 100 ° C., as well as, is not listed in GADSL. Cyclohexane and heptane are known to have a boiling point of approximately 81° C. and approximately 98° C., respectively. When this organic solvent mixture is used, the following advantages can be achieved:
solubility of the ethylene-based polymer therein is not degraded;
the solute, ethylene-based polymer remains stable in the process of dissolution at elevated temperature;
the amount of the solvent never decrease dramatically; and
a highly concentrated solution of ethylene-based polymer can be prepared.

To 20 g of the organic solvent mixture, 2 g of polyethylene powder (ethylene-based polymer component) and each 0.2, 0.6, 1.0 and 1.4 g of hydrophobic magnesium hydroxide powder were added, and were dissolved with heating at 80° C. For further detail, the afore-mentioned hydrophobic magnesium hydroxide was preferably prepared by treating magnesium hydroxide with the hydrophobizing agent in advance as previously described. The polyethylene powder was obtained from SUMITOMO SEIKA CHEMICALS CO., LTD. under the name of “UF-80”, and had an average particle size of 20 ,,m. For efficient dissolution of polyethylene powder in the organic solvent, a relatively small-sized particle was selected. As a result, in the organic solvent, the polyethylene powder was dissolved and the magnesium hydroxide was dispersed.

The resulting solution of polyethylene in the organic solvent with the hydrophobic magnesium hydroxide dispersed therein was added to a non-ionic surfactant-containing aqueous solution with stirring with a homogenizer and heating at 75° C., which accordingly yielded an emulsion. In further detail, the foregoing non-ionic surfactant-containing aqueous solution was prepared by dissolving 9 g of TritonX-100 in 900 ml of water. Subsequently, the organic solvent was evaporated off or removed in a warm bath maintained at 80° C. with continuous stirring. During this evaporation process, polyethylene particle having magnesium hydroxide therein was precipitated and collected. This collected polyethylene particle was washed with water, and dried to yield an ethylene-based polymer composite particle in accordance with the present invention.

The afore-mentioned emulsion was constantly maintained at a temperature higher than 64° C., a clouding point of the TritonX-100. In this case, while TritonX-100 was not present as a micelle in the emulsion, the emulsion remained stable.

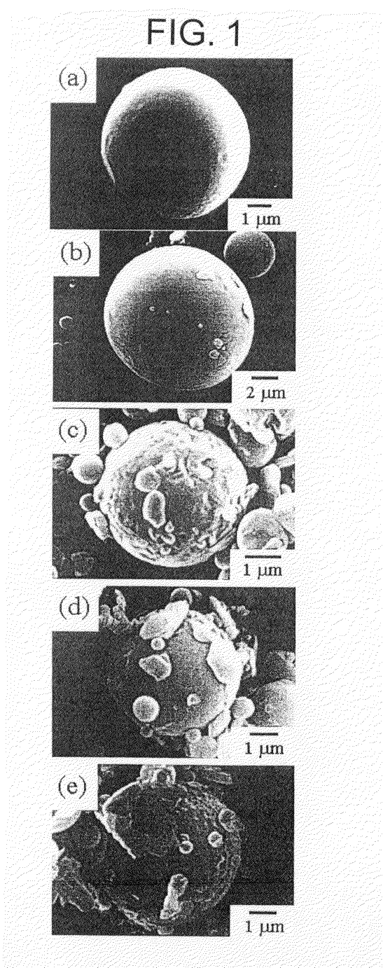

FIGS. 1(b) through 1(e) each represents a transmission electro microscopy (TEM) of ethylene-based resin composite particle as prepared by adding 10, 30, 50, and 70 parts by weight of the hydrophobic magnesium hydroxide based on the total of 100 parts by weight of the ethylene-based resin polymer used. Further, FIG. 1(a) represents a transmission electron microscopy (TEM) of a comparative example, an ethylene-based resin composite particle containing no hydrophobic magnesium hydroxide therein.

These pictures, FIGS. 1(a) through 1(e) show that the ethylene-based resin composite particle in accordance with the present invention has a small-sized, approximately spherical form, as well as, comprises the hydrophobic magnesium hydroxide particle homogeneously dispersed in its surface. Specifically, the ethylene-based resin composite particle as prepared in this example had a particle diameter of approximately 5,,m.

### [Comparison of the Amount of Magnesium Hydroxide Originally Added in the Preparation Process and the Measured Content of Magnesium Hydroxide in the Final Ethylene-Based Resin Composite Particle]

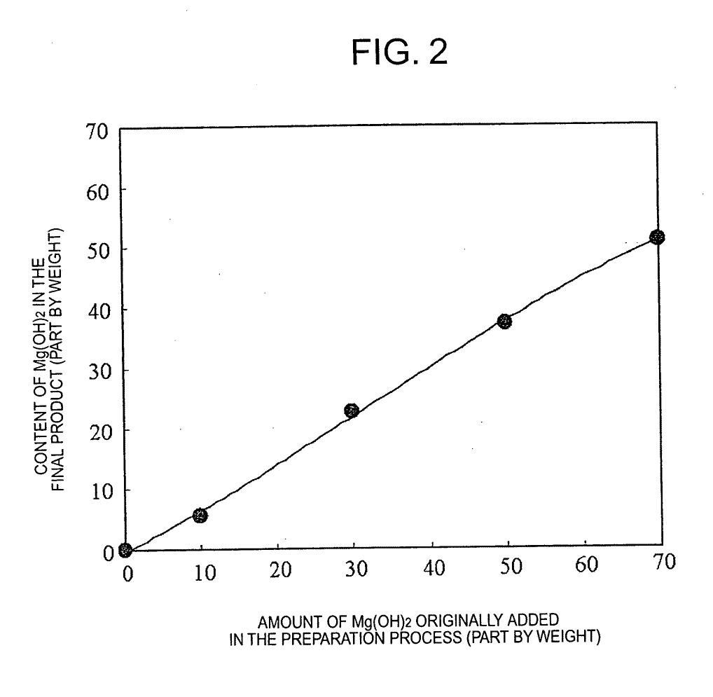

The actual content of the magnesium hydroxide in the final product ethylene-based resin composite particle in accordance with the present invention was determined. In further detail, the resulting ethylene-based resin composite particle was calcinated at 1000° C. with air supplied, the actual content of the magnesium hydroxide in the final product was directly measured from the amount of magnesium hydroxide remained after the calcination. FIG. 2 shows the relationship between the amount of magnesium hydroxide originally added in the preparation process of the ethylene-based resin composite particle and the measured content of the magnesium hydroxide of the final product ethylene-based resin composite particle.

In view of FIG. 2, the actual content of the magnesium hydroxide in the final product ethylene-based resin composite particle corresponded to approximately 70 percents on the basis of the amount of magnesium hydroxide (i.e., 100 percents) originally added in the preparation process of the ethylene-based resin composite particle. Further, although the ethylene-based resin composite particle had a very small particle size, for example, approximately 5 ,,m, it had high content of magnesium hydroxide therein.

### Comparison with the Conventional Technology

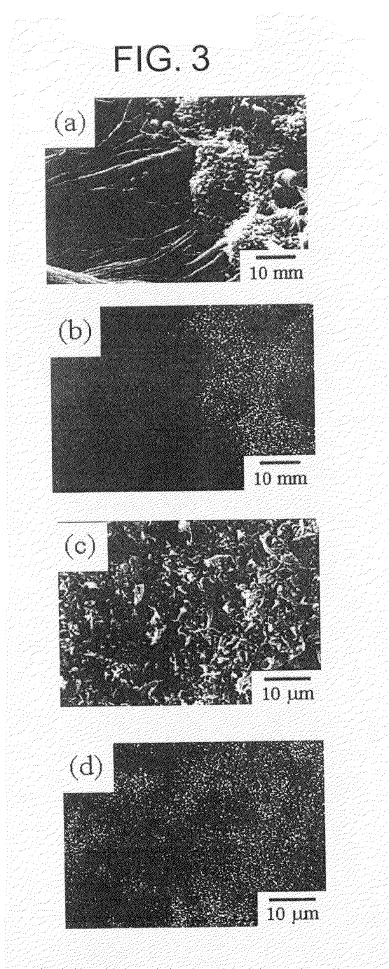

FIGS. 3(a) and 3(b) respectively show a transmission electron microscopy of the broken-out section (i.e., fracture cross section) of a conventional molded article, and an energy dispersive C-ray spectrometry with respect to a magnesium atom in the associated broken-out section. In FIG. 3(b), a white-colored portion represents the presence of the magnesium atom. In further detail, the conventional molded article was prepared as follows: The polyethylene powder was obtained from SUMITOMO SEIKA CHEMICALS CO., LTD. under the name of “UF-80”, and had an average particle size of 20 ,,m. 0.2 G of the mixture of polyethylene powder and the hydrophobic magnesium hydroxide at weight ratio of 2:1 was placed in a mold and was then shaped by means of uniaxial pressing. Subsequently, the shaped product thus obtained was heated at 150° C. for 2 hours to yield a cylindrically-shaped composite material having a height of 2 mm and a diameter of 10 mm.

FIGS. 3(c) and 3(d) respectively show a transmission electron microscopy of the broken-out section (i.e., fracture cross section) of a molded article produced by the use of the ethylene-based resin composite particle in accordance with the present invention, and an energy dispersive C-ray spectrometry with respect to magnesium atom in the associated broken-out section. In FIG. 3(d), a white-colored portion represents the presence of magnesium atom. In further detail, the ethylene-based resin composite particle in accordance with the present invention was prepared by mixing or combining ethylene-based polymer and hydrophobic magnesium hydroxide at weight ratio of 100:70. The molded article used in this example was prepared as follows: The polyethylene powder was obtained from SUMITOMO SEIKA CHEMICALS CO., LTD. under the name of “UF-80”, and had an average particle size of 20 ,,m. 0.2 G of the mixture of the polyethylene powder and the hydrophobic magnesium hydroxide was placed in a mold and was then shaped by means of uniaxial pressing. Subsequently, the shaped product thus obtained was heated at 150° C. for 2 hours to yield a cylindrically-shaped composite material having a height of 2 mm and a diameter of 10 mm.

### INDUSTRIAL APPLICABILITY

The present invention can provide several advantages in comparison with the conventional technology in the art, as follows:

Firstly, when a environmentally-friendly method for preparing an ethylene-based resin composite particle in accordance with the present invention is used, there is easily and economically achieved polyolefin-based composite material having a relatively small-sized, approximately spherical form; comprising a functional filler homogeneously dispersed therein; being compatible with other resin pellets or components; and inflicting minimal harm on the environment.

Secondly, since the ethylene-based resin composite particle in accordance with the present invention has a small-sized, approximately spherical form and contains the functional filler homogeneously dispersed therein, it can be uniformly blended or mixed with other resin pellets or components. Further, the ethylene-based resin composite particle in accordance with the present invention substantially inflicts minimal harm on the environment.

1. An environmentally friendly method for producing an ethylene-based resin composite particle, comprising:
(a) dissolving ethylene-based polymer in environment-friendly organic solvent separable from aqueous phase and dispersing hydrophobic filler in the organic solvent to form solution of ethylene-based polymer in the organic solvent;
(b) emulsifying the solution obtained in step (a) in non-ionic surfactant-containing aqueous solution;
(c) heating the emulsion obtained in step (b) to remove the organic solvent; and
(d) recovering a precipitate the ethylene-based resin composite particle containing the hydrophobic filler therein.

2. An ethylene-based resin composite particle produced by a process comprising:
(a) dissolving ethylene-based polymer in environment-friendly organic solvent separable from aqueous phase and dispersing hydrophobic filler in the organic solvent to form solution of ethylene-based polymer in the organic solvent;
(b) emulsifying the solution obtained in step (a) in non-ionic surfactant-containing aqueous solution;
(c) heating the emulsion obtained in step (b) to remove the organic solvent; and
(d) recovering a precipitate the ethylene-based resin composite particle containing the hydrophobic filler therein.
